(19) United States
(12) Patent Application Publication
(10) Pub. No.: US 2018/0285999 A1
(43) Pub. Date: Oct. 4, 2018

(54) ONLINE COMMUNITY BASED DISASTER PREPAREDNESS AND RECOVERY SYSTEM AND METHOD

(71) Applicant: Carolyn Usinger, Carson City, NV (US)

(72) Inventor: Carolyn Usinger, Carson City, NV (US)

(21) Appl. No.: 15/943,501

(22) Filed: Apr. 2, 2018

Related U.S. Application Data
(60) Provisional application No. 62/479,467, filed on Mar. 31, 2017.

(51) Int. Cl. G06Q 50/26; G06Q 50/00; H04L 29/08; G06F 17/30

(52) U.S. Cl. CPC G06Q 50/26; G06F 17/3089; H04L 67/306; G06Q 50/01

(57) ABSTRACT

A disaster preparation and recovery support system and method system are disclosed. The system and method may include a website establishing a community of entities linked to the website that provide disaster recovery resources. The system would encourage members to develop, update, and maintain a disaster recovery plan within the provided online tools. The system would assist with help in keeping the disaster recovery plan up-to-date with tools and reminders as well as the implementation of such a plan in the event of a disaster and during non-disaster periods. The present invention includes a series of online tools to help businesses reopen faster, retain customers, and obtain new customers, and methods for community officials to post information in an organized way that is convenient for the community.

### RELATED APPLICATIONS

This Application claims the benefit of provisional application 62/479,467 filed Mar. 31,2017.

### TECHNICAL FIELD OF THE DISCLOSURE

The present embodiment relates in general to disaster preparedness and recovery systems and, in particular, to an online, whole community approach to disaster preparedness and recovery.

### BACKGROUND OF THE DISCLOSURE AND DESCRIPTION OF THE RELATED ART

Disasters are unpredictable, but they do happen somewhere almost every day. Quick and smooth recovery is obviously critical to those facing a disaster. Yet hardly any systems or products are currently offered to prepare for and recover from disasters. For purposes of this document, disasters can include events causing physical damage to an individual or group, or may occur in a business environment in which quick recovery is an integral part of continuing the business. Traditionally, the government takes the role of ensuring public safety and restoring infrastructure. Government has also expanded to offer certain programs to assist in the recovery, however these are limited in scope and time. There is a large gap between what government offers and what businesses and people need to get back to where they were prior to the disaster. The present invention includes a system that integrates all aspects from disaster preparation to recovery, with the ability for businesses, government, and people to work together to meet unmet needs for disaster recovery.

Imagine being a business owner whose place of business has suddenly been destroyed due to a fire, flood, or earthquake. You would immediately need access to new or temporary location, computer and other equipment, and supplies.

You would also need a way to communicate with customers or clients, employees, and government officials for permit requirements. This is just the beginning of the products or services needed for the business to reopen. Most disaster recovery is assisted by the government and is focused on saving people's lives and preventing immediate physical harm to people. This is obviously very important, but it does nothing to assist businesses, organizations, families, and individuals in getting back to where they were prior to the disaster.

A business whose place of business has suddenly been destroyed may immediately need access to at least one of the following goods and services (and this is far from an exhaustive list):
1. A lease for an adequate new or temporary location.
2. A new phone system and service installation.
3. A new server and computer system
4. A new internet system and service.
5. A new stockpile of office supplies.
6. New business equipment.

To reopen your business, you would need access to these and many other resources QUICKLY. The phrase “time is of the essence” is applicable in this context more than perhaps any other.

Insurance (sometimes) provides cash to the affected people and entities, but does not provide quick access to recovery resources. Further, insurance does not provide the steps for getting back to normal following business disaster. Insurance, for instance, does not provide any expedited access to the goods and services above.

Therefore, there is a current long felt but yet unmet need for strong recovery methods to ensure continuous operation and minimize disruptions in the event of a man-made or natural disaster. Even though preparation is considered “optional” by most people and businesses, after a disaster they expect immediate support for recovery. Given the government's responsibilities of preserving public safety and restoring infrastructure, “immediate” government support for other services is not reasonable. Therefore, there is a need for the community to help each other, rather than depend on government, for help in disaster recovery.

As well, there is a need for a method and system that would provide disaster communication and recovery tools for both business disasters and personal physical disasters. Such a system and method would keep information relevant to disaster recovery updated. Such a system and method would also provide a contacts list and disaster recovery plan and tools before the occurrence of the disaster so that recovery time from the disaster is minimized The present embodiment overcomes existing shortcomings in this area by accomplishing these objectives.

There is also a need by community officials to provide reliable information to the community in an organized, controlled way, and a need to get information from the community to prioritize recovery efforts. “Community officials” is often comprised of multi-jurisdictions and multiple departments which make information available using separate communication systems. This makes it difficult for the public to quickly obtain information. These channels usually do not have two-way communication capabilities where the public can easily ask questions.

### SUMMARY OF THE DISCLOSURE

The present invention includes an online community network and platform established to provide an entity with fast access to resources necessary to prepare, communicate and recover.

The community may include at least one host entity responsible for managing the disaster preparedness and recovery system for a particular community. For instance, the host may be a local chamber of commerce, a homeowner's association, a county, city, or municipal government, a trade association, or the like. The community would include community members or parties interested in participating in the network program with the community, and having some influence (business or personal), as well as businesses, organizations, and other entities that provide community services relevant to servicing the community and its members, including disaster preparedness and/or disaster recovery. Such community resources may include (without limitation) insurance claims support, support for requesting federal disaster relief funding, contacts with businesses providing products or services needed to recover, contacts with local government and non-profit agencies, contacts with people who can translate for non-English speaking residents, and more.

A member afflicted by a disaster should have ready access to the resources that the community may provide.

As well, the website would assist with publicizing needs of the entity affected by the disaster; and encouraging the community entities to provide the affected entity affected with disaster recovery resources.

The system would encourage members to develop, update, and maintain a disaster recovery plan within the provided online tools. The system would assist with help in keeping the disaster recovery plan up-to-date with tools and reminders as well as the implementation of such a plan in the event of a disaster and during non-disaster periods.

The present invention includes a series of online tools to help businesses reopen faster, retain customers, and obtain new customers. These online tools include, but are not limited to (1) prepaid coupons for products or services with a back-end that provides funds directly to business and notifies purchaser and business when the coupon can be redeemed; (2) a notification and tracking system that alerts officials if a business needs assistance (such as permitting) so that their business can reopen after a disaster. This is a program Applicant refers to as “Rebuild Express.”

The present invention may further include methods to provide a series of web-based tools to help businesses, re-open their business faster, retain customers and obtain new ones.

The present invention further includes a series of online tools to help people communicate and share information before and after a disaster.

1) Forums that allow two-way, private communication between:
Businesses and employees
Community officials and the entire network
Community disaster officials with each other
Private groups with their groups
Associations with their members

While the foregoing forums themselves may not be unique; the integration of forums so that all members of the community are connected within the same system is unique.

The present invention provides a method for businesses to share portions of their disaster plan with their employees, so that if the owner/manager is unavailable at the time of a disaster, employees can access evacuation and shut-down procedures for the business.

The present invention may further include systems and/or methods for the integration of chat lines, online meeting capability, task management, employee time scheduling, text messaging and email messaging into the disaster communication and recovery process.

The present invention provides a method for community officials from multiple jurisdictions and departments to post information in an organized way that is convenient for the community. It also allows the public to ask questions and share information in a controlled forum so that the official can answer questions, prioritize information, and delete incorrect or inappropriate entries.

The present invention provides a method for community officials to collect information about the losses and needs of the community.

To minimize the limitations found in the existing systems and methods, and to minimize other limitations that will be apparent upon the reading of the specifications, preferred embodiment of the present invention provides a system and method for the purpose of preparing for, communicating and recovering from a disaster.

The system comprises at least one communication device connected to a disaster recovery system via a network. The at least one communication device is configured to allow an entity to provide a plurality of input parameters including the type of disaster caused, the details of the disaster, location of the user the user's status and so on. Then at least one communication device is selected from a group consisting of: a cellular telephone, a smartphone, a wireless-enabled personal digital assistant, a tablet, a personal computer, a notebook and a mobile device. The disaster recovery system includes a disaster recovery server residing on a central computer having a processor installed with a disaster recovery application and coupled with a memory unit integrated with a central database. The user can access the disaster recovery application via a website or a mobile application utilizing the at least one communication device. The user can login to the disaster recovery application using the login credentials provided to the user.

The disaster recovery system further comprises a parameter input module, a contact list module, a disaster plans module, a resources module, a forums module, a business tools module, a community tools module and an admin center module. The parameter input module is located at the processor and configured to receive the input parameters including the user's status type of disaster, the details of the disaster and the location of the disaster. The contact list module is configured to store the contact details of all the users of the disaster recovery system and is located at the processor of the disaster recovery system. The contact list module contains details of business personnel, customers, suppliers, family members and others. The disaster plans module is located at the processor of the disaster recovery system and prepares a plurality of disaster plans related to business disasters and personal physical disasters. The resources module is located at the processor of the disaster recovery system and provides a plurality of recovery resources to the user in the event of a disaster. The forums module is located at the processor of the disaster recovery system and provides open and private forums relating to business, employees, personal, community, organizational, government and visitors. The business tools module is located at the processor of the disaster recovery system and helps to manage, recover and grow the business during normal operations to a or any crisis or business disaster. The community tools module is located at the processor of the disaster recovery system and helps to manage the public's needs and direct the public in times of crisis and afterwards. The admin center module is located at the processor of the disaster recovery system and host and manages the disaster recovery application and has the full access of the application. The network is a data communication network selected from a group consisting of: Internet, a local area network (LAN), a wide area network (WAN), wired Ethernet, wireless Ethernet and cellular wireless network.

The method for the purpose of preparing for and recovering from a disaster includes providing the disaster recovery system installed with the disaster recovery application which is in communication with at least one communication device via the network. The user can login to the disaster recovery application via a website or a mobile application through the login credentials provided. Then providing a plurality of input parameters like the type of disaster, details of the disaster and user status location of the user to the disaster recovery application through the parameter input module. Accessing the forums on the forums module and selecting a particular forum based on the plurality of input parameters provided by the user and determining the disaster plan from the disaster plan module based on the selected forum by the disaster recovery application. Then selecting a community tool from the community tool module or a business tool from the business tool module depending on the disaster plan selected by the disaster recovery application. Providing the resources from the resources module of the disaster recovery application to recover from the disaster. Providing the disaster plan and the resources to the user via the at least one communication device to recover from the disaster and updating the disaster plan by the disaster plan module of the disaster recovery application periodically, or at will.

### OBJECTIVES OF THE PRESENT INVENTION

It is a first objective of the present invention to provide a method and system that would provide disaster recovery for both business disasters and personal physical disasters.

A second objective of the present invention is to provide system and method that would provide resources for the purpose of disaster preparedness and recovery.

A third objective of the present invention is to provide a system and method that would keep disaster preparation and recovery information relevant and updated.

A fourth objective of the present invitation is to provide communication methods that facilitate sharing disaster recovery information between members of the network, while protecting private information.

A fifth objective of the present invention is to provide a system and method so that businesses and families can create a disaster plan and contacts list before the occurrence of the disaster so that recovery time from the disaster is minimized

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a high level block diagram of a system for the purpose of preparing for and recovery from a disaster. in accordance with the preferred embodiment of the present invention;

FIG. 2 illustrates a high level operational block diagram of the system for the purpose of preparing for and recovery from the disaster in accordance with the preferred embodiment of the present invention; and

FIG. 3 illustrates a flowchart of a method for the purpose of preparing for and recovery from the disaster in accordance with the preferred embodiment of the present invention.

### DETAILED DESCRIPTION OF THE DISCLOSURE AND DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

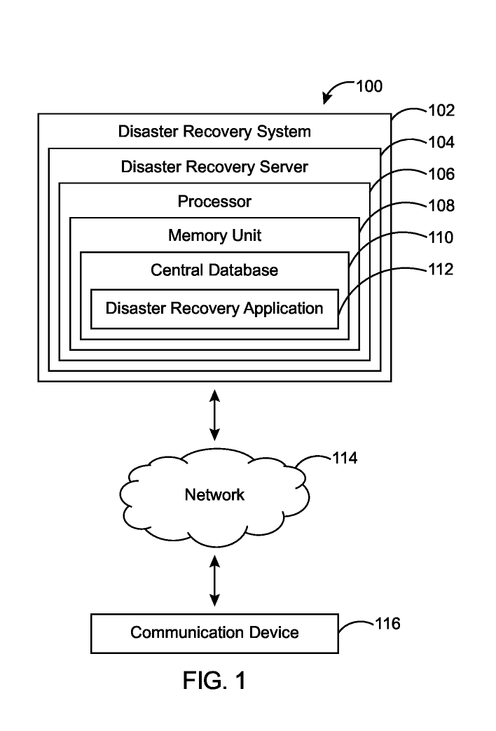

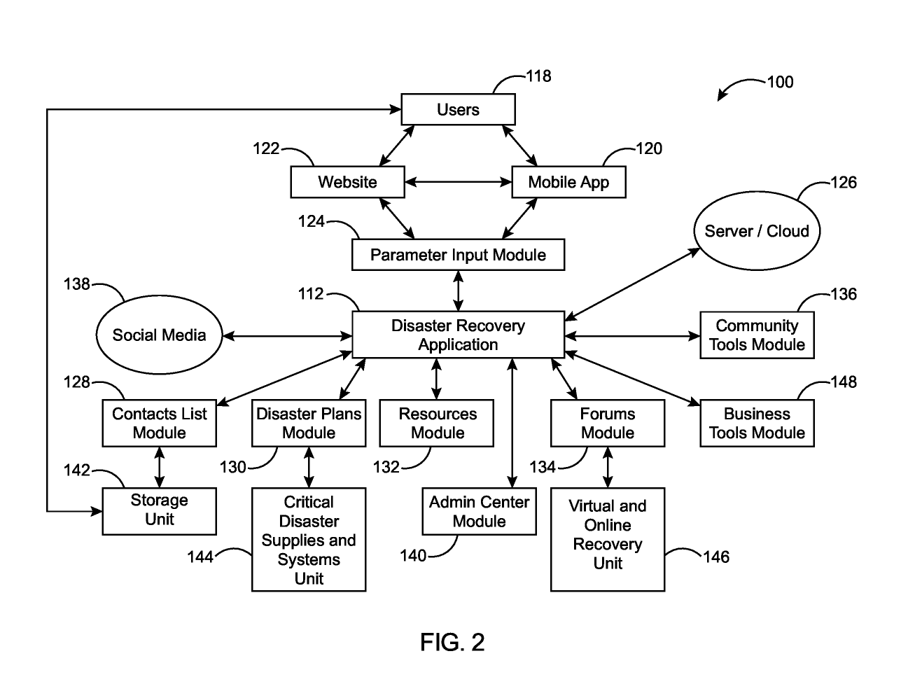

Turning first to FIGS. 1 and 2, block diagrams of a system 100 for the purpose of preparation for, communication during, and recovery from a disaster in accordance with the preferred embodiment of the present invention are illustrated. The disasters can include physical disasters such as an explosion, a building collapse, local flooding, a fire, and so on or business disaster caused by the factors such as business operations, physical and information technology (IT) infrastructure, company employees, customers, suppliers, business partners, revenues, costs and customer service levels. The system 100 comprises at least one communication device 116 connected to a disaster recovery system 102 via a network 114. The at least one communication device 116 is configured to allow an entity to provide a plurality of input parameters including the type of disaster caused, the details of the disaster, location of the user and so on. The at least one communication device 116 is selected from a group consisting of: a cellular telephone, a smartphone, a wireless-enabled personal digital assistant, a tablet, a personal computer, a notebook and a mobile device. The entity can be users selected from a group consisting of: business personnel, community members and visitors. The business personnel may include owners, leaders, managers, supervisors, employees, liaisons, vendors or suppliers. The community members may include residents, family members, relatives, friends, acquaintances or officials. Visitors may include any one not living within an assigned zip code for that community or surrounding area.

The disaster recovery system 102 provides a mechanism for each user 118 in a community to share information about a disaster and support each other to recover quickly from the disaster. The disaster recovery system 102 includes a disaster recovery server 104 residing on a central computer having a processor 106 installed with a disaster recovery application 112 and coupled with a memory unit 108 integrated with a central database 110 as illustrated in FIG. 1. The user 118 can access the disaster recovery application 112 via a website 122 or a mobile application 120 utilizing the at least one communication device 116. The user 118 can login to the disaster recovery application 112 using the login credentials provided to the user 118. The disaster recovery system 102 further comprises a parameter input module 124, a contact list module 128, a disaster plans module 130, a resources module 132, a forums module 134, a business tools module 148, a community tools module 136 and an admin center module 140 as illustrated in FIG. 2. The parameter input module 124 is located at the processor 106 and configured to receive the input parameters including the type of disaster, the details of the disaster and the location of the disaster.

These input parameters are provided by the user 118 through the at least one communication device 116 via the website 122 or the mobile application 120 having the disaster recovery application 112. The contact list module 128 is configured to store the contact details of all the users 118 of the disaster recovery system 102 and is located at the processor 106 of the disaster recovery system 102. The contact list module 128 contains details of business personnel, community members and visitors. The contact list module 128 may contain unlimited number of contacts and they can use the having the disaster recovery application 112 in event of a disaster.

The disaster plans module 130 is located at the processor 106 of the disaster recovery system 102 and prepares a plurality of disaster plans related to business disasters and personal physical disasters. The disaster plans module 130 further include a critical disaster supplies and system unit 144 which prepare critical disaster plans, allows communication of the critical plan with the user and provide access to the recovery essentials such as disaster supplies, computer backup, insurance recommendations, disaster prevention services, identity theft site access, etc.

The resources module 132 is located at the processor 106 of the disaster recovery system 102 and provides a plurality of recovery resources to the user in the event of a disaster. The plurality of recovery resources provided by the resources module 132 may include, but not limited to, online resources for businesses and families, resources in multiple languages, resources for special needs such as for blind, disabled, deaf, mental and physical ailments, elderly people etc., documents posted by businesses for their employees, documents posted by community leaders and documents posted by forum leaders. The plurality of recovery resources may further include insurance claims support, support for requesting federal disaster relief funding, contact with lessors of business space, contact with providers of business phone systems, contact with providers of business technology service, contact with providers of generators, and contact with other to businesses providing products or services needed for disaster recovery.

The forums module 134 is located at the processor 106 of the disaster recovery system 102 and provides open and private forums relating to business, employees, personal, community, organizational, government and visitors. The forums module 134 may further include a virtual and online recovery unit which stores forums established for crisis/disaster preparation, communication and recovery; forums established for ongoing business, personal and/or community growth and forums in any language and for any purpose.

The business tools module 148 is located at the processor 106 of the disaster recovery system 102 and helps to manage, recover and grow the business from a business disaster. The business tools module 148 provides access to disaster coupons, boost and rebuild express such as employee intranet and scheduler, marketing coupons, discounts of any kind, special offers, priority management, crowdfunding, thank you coupons etc. The community tools module 136 is located at the processor 106 of the disaster recovery system 102 and helps to manage and direct the public in times of crisis.

The community tools module 136 performs certain task at the time of crisis such as evacuation of people, provides shelter and donations, volunteer centers, provide calendars, resources for special needs/vulnerabilities, helps in critical resource management, mapping, helps in special skills identification, provides communication methods for businesses and neighborhoods to report fraud and theft to each other and the police. The community tools module 136 also includes public forums hosted by officials, chamber of commerce members and other community leaders. The public forums include leadership forum, citizen's emergency response team (CERT) forum, forums hosted by local associations. The community tools module 136 help community leaders to manage public needs during and after a disaster. This module may include accessible CERT info, vulnerable population questionnaires, access to special needs from community, community 2-way forums to post and share information, volunteer center, donation center, lost/found center, mapping tools etc.

The admin center module 140 is located at the processor 106 of the disaster recovery system 102 and host and manages the disaster recovery application 112 and has the full access of the application 112. All the data are stored in the central database 110 of the disaster recovery sever or cloud 126 with backup systems. The network 114 is a data communication network selected from a group consisting of: Internet, a local area network (LAN), a wide area network (WAN), wired Ethernet, wireless Ethernet and cellular wireless network.

The disaster recovery system 102 of the present embodiment serves multiple roles for multiple communities. The disaster recovery system 102 provides access to multiple communities such as business personnel, employees, residents, families, administrators, associations, managers at multiple locations and visitors. Thus the disaster recovery system 102 can be customized depending on the needs of the user. In one embodiment of the present invention, the disaster recovery system 102 allows sharing of information between business and their employees. This embodiment shares documents posted by the business, share tasks posted by either the business or the employee, share disaster status; share intranet for the business (with employees having limited access to certain information and tools), share portions of the business disaster plan, share a private 2-way communication forum. The system 100 allows business to identify employees who can have higher level access to certain documents and instructions.

In one embodiment of the present invention, the disaster recovery system 102 allows sharing of information between business and administrator. This embodiment shares information posted by business for recovery needs, share status of business, share employee list so employees can be invited to participate in the network, share special needs for business and family (Z-5) are shared with HIPAA-approved personnel, share information on whether they can sell, loan, or donate items critical to the recovery.

In another embodiment of the present invention, the disaster recovery system 102 allows sharing of information between business and all others in the contact list. This embodiment shares information about the business disaster status, temporary location, and can promote the business to the network.

In still another embodiment of the present invention, the disaster recovery system 102 allows sharing of information with all contacts in the contact list module. This embodiment shares information about the needs, the resources, the missing pets, people or things and about hiring information.

In still another embodiment of the present application 112 allows business owner/managers that oversee multiple divisions or departments to connect with multiple business and employee accounts. The application allows sharing corporate disaster documents, sharing a corporate forum, and sharing a corporate disaster plan.

In still another embodiment of the present application 112 allows business owners, employees and residents to create and/or participate in a program Applicants refer to as “Ready Watch.” which is a small group to alert each other for security and/or business related concerns. This embodiment of the system allows users to participate without having to share email addresses or names.

In still another embodiment of the present application 112 allows businesses, employees and residents to opt in to forums hosted by local associations, and to share the disaster information with the local associations.

In still another embodiment of the present application 112 allows businesses, employees and residents to be invited to forums hosted by regional and national associations, and share the disaster information with these groups. In this embodiment the associations can provide links to their affiliates, so that the affiliates can participate in the forums and support the members' needs after a disaster.

In still another embodiment of the present application 112 allows businesses, employees and residents to create or participate in private group forums, where they can share information and needs before and after a disaster.

In still another embodiment of the present application 112 allows the disaster recovery application to post and share information about the particular disaster such as the type of disaster, details of the disaster and location of the user on any of the social media platforms 138 to publicize the needs of the user so that a multiple number of users in the social platform 138 can view about the disaster and can provide suggestions, immediate help or resources to overcome the disaster if the user's location is near.

Another embodiment of the present application 112 allows the entire users in the contact list to connect to other communities in disaster recovery application and can access information and participate in forums as a guest.

Another embodiment of the present application 112 allows updating the disaster recovery application 112 periodically, for example, within a period of 6 months to keep information up-to-date. The updating the disaster recovery application 112 updates business, employee and resident contact lists, business, employee and resident disaster plans, admin contact lists, vulnerable population/special needs information and businesses that can provide critical resources. Updating the disaster recovery application allow the users to add or delete names, request users on the contacts list to update information, the users who has not responded are reminded to update after 3 days and are notified to update information after 7 days.

The processor 106 is an electronic circuit that executes computer programs. The memory unit stores programs, applications, and data. For example, the parameter input module 124, the contact list module 128, the disaster plans module 130, the resources module 132, the forums module 134, the business tools module 148, the community tools module 136 and the admin center module 140 of the disaster recovery application 112 are stored on the memory unit 108 of the disaster recovery system 102. The memory unit 108 is, for example, a random-access memory (RAM) or another type of dynamic storage device that stores information and instructions for execution by the processor. The memory unit 108 also stores temporary variables and other intermediate information used during execution of the instructions by the processor.

The disaster recovery system 102 further comprises a read only memory (ROM) or another type of static storage device that stores static information and instructions for the processor. The disaster recovery system 102 that executes the disaster recovery application 112 communicates with the at least one communication device 116 through the network 114. The network 114 is, for example, a local area network (LAN), a wide area network, a mobile communication network, a signaling system number 7 (SS7) network, a wired telephony network, any generic data network, etc.

The disaster recovery system 102 employs an operating system for performing multiple tasks. The operating system is responsible for management and coordination of activities and sharing of resources of the disaster recovery system. The operating system further manages security of the disaster recovery system, peripheral devices connected to the disaster recovery system, and network connections. The operating system recognizes keyboard inputs and pointing device inputs of an operator, output display, files, and directories stored. The operating system on the disaster recovery system executes different programs, for example, a web browser, an electronic mail (email) application, a customized program, etc., initiated by the user of the disaster recovery application using the processor 106. The operating system monitors the use of the processor.

The processor 106 retrieves the instructions for executing the modules, for example, the parameter input module 124, the contact list module 128, the disaster plans module 130, the resources module 132, the forums module 134, the business tools module 148, the community tools module 136 and the admin center module 140 of the disaster recovery application 112 are stored on the memory unit 108 of the disaster recovery system 102 from the program memory in the form of signals. A program determines the location of the instructions in the program memory. The program stores a number that identifies the current position in the program of the modules, for example, the parameter input module 124, the contact list module 128, the disaster plans module 130, the resources module 132, the forums module 134, the business tools module 148, the community tools module 136 and the admin center module 140 of the disaster recovery application 112. The instructions fetched by the processor from the program memory after being processed are decoded. The instructions are placed in an instruction register (IR) in the processor. After processing and decoding, the processor 106 executes the instructions. For example, the parameter input module 124 defines instructions to determine the input parameters based on the disaster caused, the details of the disaster, location of the user provided by the user through the at least one communication device 116.

The disaster plans module 130 defines instructions to provide the disaster plan based on the plurality of input parameters provided by the user through the at least one communication device 116. The forums module 134 defines instructions to provide forums in accordance with the plurality of input parameters provided by the user 118. The resources module 132 defines instructions to provide the availability of resources pertaining to the type of disaster encountered retrieved from the plurality of input parameters through the at least one communication device 116.

The business tools module 148 and the community tools module 136 define instructions to provide business recovery details or community recovery details respectively to the user 118 via the website 122 or the mobile application 120.

At the time of execution, the instructions stored in the instruction register are examined to determine the operations to be performed. The operations include arithmetic and logic operations. The processor 106 then performs the specified operations. The operating system performs multiple routines for performing a number of tasks required to assign the input devices, the output devices, and memory for execution of the modules, for example, the parameter input module 124, the contact list module 128, the disaster plans module 130, the resources module 132, the forums module 134, the business tools module 148, the community tools module 136 and the admin center module 140 of the disaster recovery application 112. The tasks performed by the operating system comprise assigning memory to the modules, moving data between the memory unit and disk units, and handling input/output operations. The operating system performs the tasks on request by the operations and after performing the tasks, the operating system transfers the execution control back to the processor 106. The processor 106 continues the execution to obtain one or more outputs. The outputs of the execution of the modules, for example, the parameter input module 124, the contact list module 128, the disaster plans module 130, the resources module 132, the forums module 134, the business tools module 148, the community tools module 136 and the admin center module 140 of the disaster recovery application 112 are displayed, for example, to the users 118 of the disaster recovery application 112.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor, except for a transitory, propagating signal. The computer program product disclosed herein comprises one or more computer program codes for method for the purpose of preparing for and recovery from the disaster.

In one embodiment, the disaster recovery server 104 provides a website for managing or controlling the disaster recovery plans, resources available, contact list, forums and tools to manage and recover a business or community disaster where the users can input the plurality of input parameters. The user 118 can provide on the disaster caused, the details of the disaster, and location of the user or other information as the plurality of input parameters. The website 122 enables the user to create an account for inputting the plurality of input parameters required for providing the disaster recovery plan.

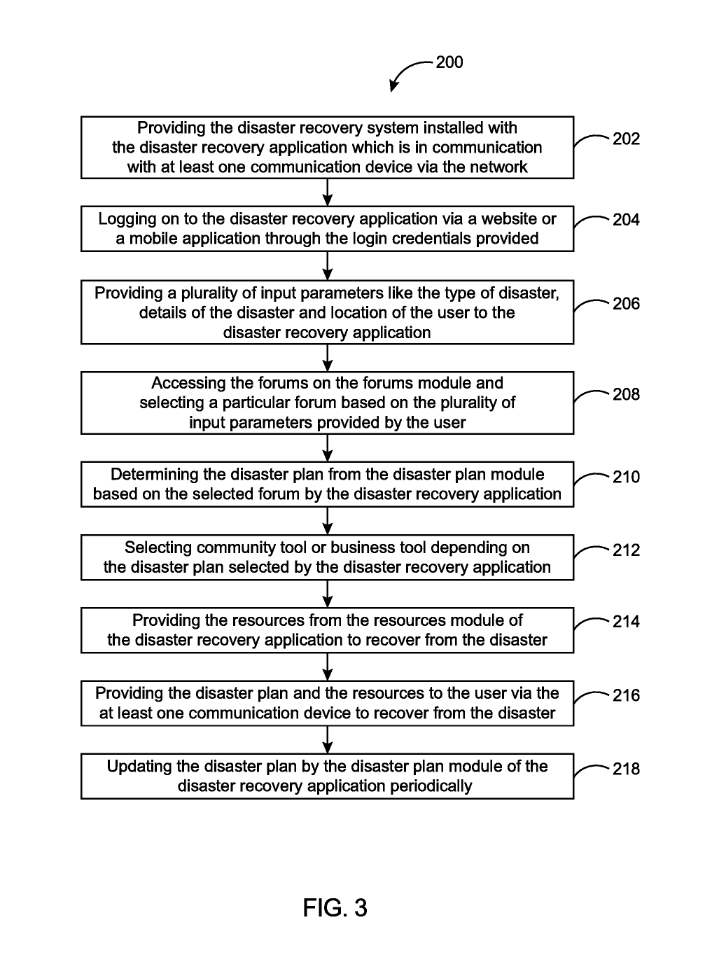

FIG. 3 illustrates a flowchart of a method 200 for the purpose of preparing for and recovery from a disaster in accordance with the preferred embodiment of the present invention. The method 200 disclosed herein provides the disaster recovery system installed with the disaster recovery application which is in communication with at least one communication device via the network as indicated at block 202. The disaster recovery system includes a disaster recovery server residing on a central computer having a processor installed with a disaster recovery application and coupled with a memory unit integrated with a central database. The disaster recovery application is a software application implemented on a disaster recovery server for managing and recovering the user from the disaster. The user can Login to the disaster recovery application via a website or a mobile application through the login credentials provided as indicated at block 204. Then providing a plurality of input parameters like the type of disaster, details of the disaster and location of the user to the disaster recovery application through the parameter input module as indicated at block 206. Accessing the forums on the forums module and selecting a particular forum based on the plurality of input parameters provided by the user as indicated at block 208. As indicated in block 210, determining the disaster plan from the disaster plan module based on the selected forum by the disaster recovery application. Then selecting a community tool from the community tool module or a business tool from the business tool module depending on the disaster plan selected by the disaster recovery application as indicated at block 212. Providing the resources from the resources module of the disaster recovery application to recover from the disaster as indicated at block 214. As indicated in block 216, providing the disaster plan and the resources to the user via the at least one communication device to recover from the disaster and updating the disaster plan by the disaster plan module of the disaster recovery application periodically as indicated in block 218.

In one embodiment, a non-transitory computer-readable medium comprises computer-executable instructions stored therein for causing a computer to implement a program executable on the disaster recovery system for the purpose of preparing for and recovery from a disaster. The non-transitory computer readable storage medium comprises a USB memory, CD-ROM, flexible disc, DVD or a flash memory. In one embodiment, a non-transitory computer-readable medium comprises computer-executable instructions stored therein for causing mobility solutions to implement a program executable on the disaster recovery system that enables the user to recover from a disaster utilizing the disaster recovery application.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

It should also be understood that logic codes, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, may be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method for providing a supported entity with disaster preparation and recovery support comprising the steps of:
a. providing a website accessible via login credentials for the business thereby establishing an account for the supported entity,
b. establishing a plurality of community entities linked to the website that provide disaster recovery resources;
c. establishing a host entity responsible for managing the website;
d. providing the supported entity with access to disaster recovery resources;
e. encouraging the supported entity to enter contact information on all of its employees and owners;
f. encouraging the supported entity to periodically update the contact information;
g. establishing a disaster recovery plan for the supported entity prior to the occurrence of a disaster;
h. encouraging the supported entity to periodically update the disaster recovery plan;
i. assisting with the execution of the disaster recovery plan upon the occurrence of a disaster by connecting the entity affected by the disaster to the entities that provide disaster recovery resources;

2. The method of claim 1 wherein the system is accessible via a mobile application.

3. The method of claim 1 wherein the websites provides a forum for the discussion of topics related to disaster preparedness and recovery.

4. The method of claim 1 wherein the host entity comprises a local governmental entity.

5. The method of claim 1 wherein the host entity comprises to a home owner's association.

6. The method of claim 1 wherein the host entity comprises local chamber of commerce;

7. The method of claim 1 wherein the website provides a private toolkit where the supported entity can create a contacts list and disaster plan for both business and family.

8. The method of claim 1 wherein the disaster recovery resources comprise: insurance claims support, support for requesting federal disaster relief funding, contact with businesses providing products or services needed for disaster recovery.

9. The method of claim 1 wherein the website provides the supported entity the ability to report a status following a disaster and the status is communicated to a predetermined contact list of the supported entity.

10. The method of claim 1 wherein the website provides two-way communication forums and a series of other communication tools whereby community members can get and share information in a controlled way, thereby eliminating false, misleading, and confusing information can be eliminated.

11. The method of claim 1 further comprising the steps of:
a. publicizing needs of the entity affected by the disaster; and
b. encouraging the community entities to provide the affected entity affected with disaster recovery resources.

12. The method of claim 10 further comprising the step of promoting recovery of the supported entity by encouraging the community members to use offerings of the supported entity.
